(19) United States
(12) Patent Application Publication
(10) Pub. No.: US 2024/0332999 A1
(43) Pub. Date: Oct. 3, 2024

(54) WIRELESSLY RECHARGEABLE POWER SUPPLY DEVICE

(71) Applicant: TOYODA GOSEI CO., LTD., Kiyosu-shi (JP)

(72) Inventors: Tsubasa SUZUKI, Kiyosu-shi (JP); Yuki TOKUYAMA, Kiyosu-shi (JP); Shinichiro FUKI, Kiyosu-shi (JP); Tomokazu SAKAI, Kiyosu-shi (JP); Atsushi SUGIHARA, Kiyosu-shi (JP); Teppei ABE, Kiyosu-shi (JP)

(21) Appl. No.: 18/615,501

(22) Filed: Mar. 25, 2024

(30) Foreign Application Priority Data
Apr. 3, 2023 (JP) 2023-060213

(51) Int. Cl. H02J 7/00; H01Q 1/24; H02J 50/40

(52) U.S. Cl. CPC H02J 7/0042; H01Q 1/248; H02J 50/40

(57) ABSTRACT

A wirelessly rechargeable power supply device includes a circuit board, a power storage device, two or more antennas configured to receive power, a housing that accommodates the circuit board, the power storage device, and the two or more antennas, and a charging circuit that is mounted on the circuit board and is configured to charge the power storage device with the power received by the two or more antennas. The two or more antennas include a first antenna and a second antenna. A direction in which a sensitivity of the first antenna is lowest and a direction in which a sensitivity of the second antenna is lowest are different from each other.

### BACKGROUND

### 1. Field

The present disclosure relates to a wirelessly rechargeable power supply device.

### 2. Description of Related Art

Japanese Patent No. 6725531 discloses an AA-sized wirelessly rechargeable battery device. This device incorporates one or more antennas that rotate together with a flexible circuit board and a spatial controller that automatically rotates the flexible circuit board (see paragraphs [00651] to [00671] of the publication). In this device, the spatial controller rotates the flexible circuit board to optimally arrange the antennas.

The above-described wirelessly rechargeable battery device needs to incorporate a spatial controller.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wirelessly rechargeable power supply device includes a circuit board, a power storage device, two or more antennas configured to receive power. a housing, and a charging circuit. The housing accommodates the circuit board, the power storage device, and the two or more antennas. The charging circuit is mounted on the circuit board and is configured to charge the power storage device with the power received by the two or more antennas. The two or more antennas include a first antenna and a second antenna. A direction in which a sensitivity of the first antenna is lowest and a direction in which a sensitivity of the second antenna is lowest are different from each other.

Other features and aspects will be apparent from the following detailed description, the drawings, and the claims.

### BRIEF DESCRIPTION OF THE DRAWINGS

FIG. 1 is a block diagram showing a configuration of a wirelessly rechargeable power supply device according to a first embodiment.

FIG. 2 is a perspective view showing a configuration of the wirelessly rechargeable power supply device shown in FIG. 1.

FIG. 3A is a front view of the wirelessly rechargeable power supply device shown in FIG. 2.

FIG. 3B is a plan view of the wirelessly rechargeable power supply device shown in FIG. 3A.

FIG. 3C is a left side view of the wirelessly rechargeable power supply device shown in FIG. 3B.

FIG. 3D is a right side view of the wirelessly rechargeable power supply device shown in FIG. 3B.

FIG. 3E is a cross-sectional view taken along line 3E-3E in FIG. 3B.

FIG. 4 is an exploded perspective view of the wirelessly rechargeable power supply device shown in FIG. 2.

FIG. 5 is a plan view of the internal structure of the wirelessly rechargeable power supply device shown in FIG. 2.

FIG. 6 is a perspective view of an arrangement of a circuit board and antennas of the wirelessly rechargeable power supply device shown in FIG. 2.

FIG. 7 is a plan view of the antenna shown in FIG. 6.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B. or both A and B.”

An embodiment will now be described with reference to the drawings.

### Circuit Configuration

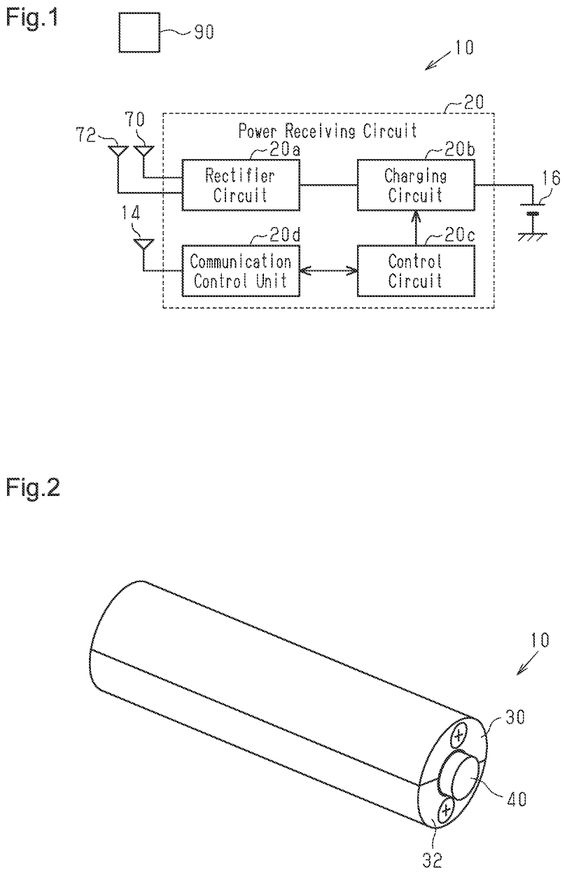

FIG. 1 shows a configuration of a wirelessly rechargeable power supply device 10 according to the present embodiment. The wirelessly rechargeable power supply device 10 includes two power receiving antennas, a communication antenna 14, a rechargeable battery 16, and a power receiving circuit 20. The two power receiving antennas include a first antenna 70 and a second antenna 72.

The first antenna 70 and the second antenna 72 receive power supplied from an external device 90 located outside the wirelessly rechargeable power supply device 10. The external device 90 is, for example, a power supply device. The power received by the first antenna 70 and the second antenna 72 is input to the power receiving circuit 20. The power receiving circuit 20 includes a rectifier circuit 20a, a charging circuit 20b, a control circuit 20c, and a communication control unit 20d.

The rectifier circuit 20a converts AC power received by the first antenna 70 and the second antenna 72 into DC power. The charging circuit 20b charges the rechargeable battery 16 with the DC power output from the rectifier circuit 20a. The control circuit 20c operates the charging circuit 20b to control the amount of charge to the rechargeable battery 16.

The communication control unit 20d, which is a communication control circuit, communicates with the external device 90 via the communication antenna 14. For example, the communication control unit 20d transmits an identification signal of the wirelessly rechargeable power supply device 10 to the external device 90 via the communication antenna 14. The communication antenna 14 is, for example, an antenna for the 2.4 GHz band. Accordingly, the wirelessly rechargeable power supply device 10 functions as a beacon. When the wirelessly rechargeable power supply device 10 transmits the identification signal, the external device 90 can detect the presence of the wirelessly rechargeable power supply device 10. The external device 90 wirelessly transmits power on condition that the presence of the wirelessly rechargeable power supply device 10 is detected. The communication control unit 20d may be further configured to exchange information regarding the amount of power supply with the external device 90. The communication method employed by the communication control unit 20d is, for example, bluetooth low energy (BLE®).

The rechargeable battery 16, which is a power storage device, is, for example, a lithium-ion rechargeable battery.

### Layout

FIG. 2 shows an outer shape of the wirelessly rechargeable power supply device 10. The wirelessly rechargeable power supply device 10 has the same shape as a dry battery. In particular, as an example, the wirelessly rechargeable power supply device 10 has the same shape and the same dimensions as those of an AA dry battery. That is, the wirelessly rechargeable power supply device 10 is a columnar member including a top surface and a bottom surface. The wirelessly rechargeable power supply device 10 includes a protruding positive electrode 40 on the top surface. The wirelessly rechargeable power supply device 10 accommodates the members shown in FIG. 1 in a space defined by a first housing 30 and a second housing 32.

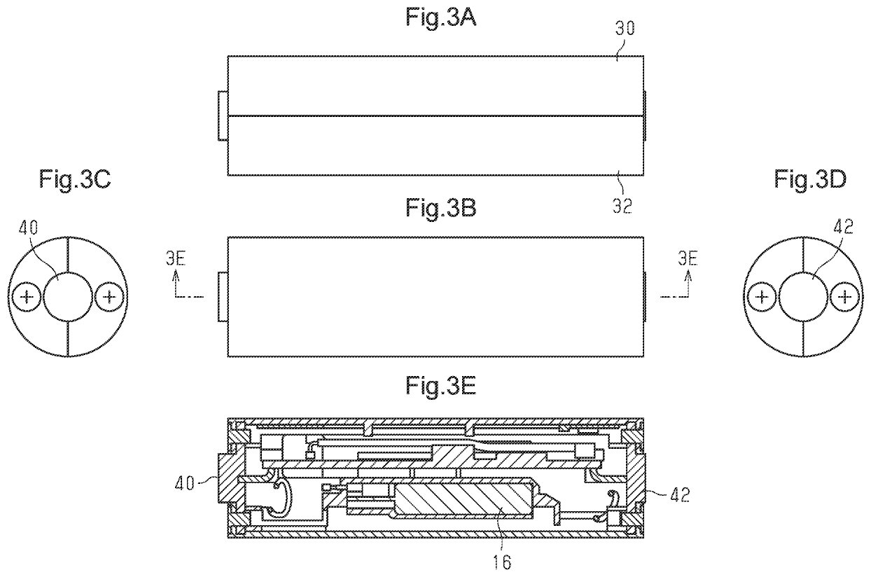

As shown from FIGS. 3A to 3E, the wirelessly rechargeable power supply device 10 includes the positive electrode 40 on the top surface and a negative electrode 42 on the bottom surface.

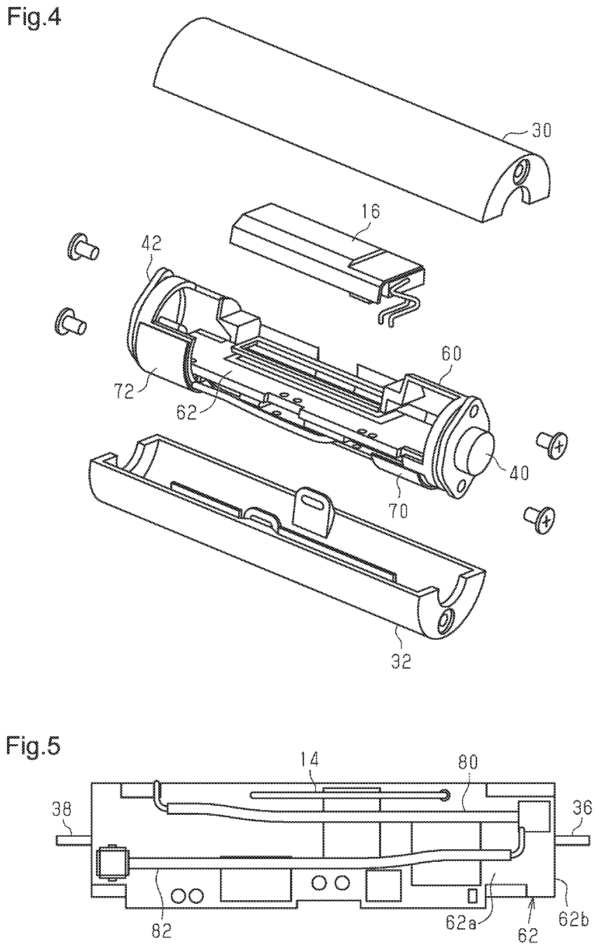

FIG. 4 is an exploded perspective view of the wirelessly rechargeable power supply device 10.

As shown in FIG. 4, the wirelessly rechargeable power supply device 10 includes a chassis 60 in a space defined by the first housing 30 and the second housing 32. A circuit board 62 is fixed to the chassis 60. A first antenna 70 and a second antenna 72 are respectively provided at opposite end portions of the chassis 60. The rechargeable battery 16 is disposed between the circuit board 62 and the first housing 30.

FIG. 5 is a diagram showing the circuit board 62 as viewed from the side facing a first main surface 62a, which is a surface of the circuit board 62 facing the second housing 32.

As shown in FIG. 5, a first coaxial cable 80 connected to the first antenna 70 and a coaxial cable 82 connected to the second antenna 72 extend on the first main surface 62a along the longitudinal direction of the circuit board 62. An electrode cable 36 connected to the positive electrode 40 and an electrode cable 38 connected to the negative electrode 42 extend from a second main surface 62b of the circuit board 62, which is a surface opposite to the first main surface 62a.

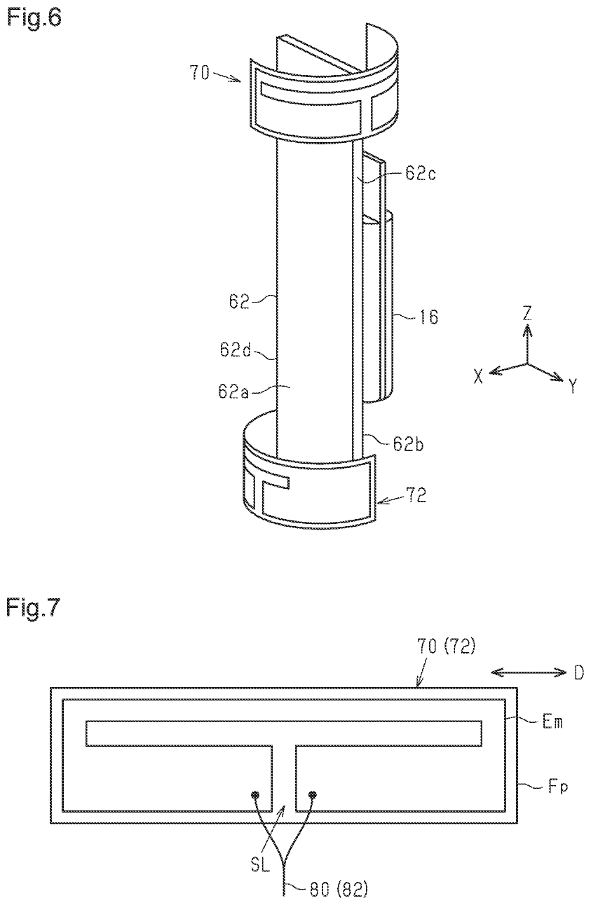

FIG. 6 shows a layout of the first antenna 70 and the second antenna 72. In FIG. 6, an axis extending in the longitudinal direction of the rectangular circuit board 62 is defined as a z-axis. In FIG. 6, the circuit board 62 is parallel to a plane including the z-axis and a y-axis.

As shown in FIG. 6, the first antenna 70 and the second antenna 72 are provided at the opposite end portions of the circuit board 62 in the longitudinal direction.

The first antenna 70 and the second antenna 72 are both dipole antennas. The first antenna 70 and the second antenna 72 are both flexible printed circuit board antennas (FPC antennas). FIG. 6 illustrates the shapes of the first antenna 70 and the second antenna 72 in a state in which the first antenna 70 and the second antenna 72 are accommodated in the space defined by the first housing 30 and the second housing 32. The first antenna 70 and the second antenna 72 thus have shapes along the inner circumferential surfaces of the first housing 30 and the second housing 32. This is because the first antenna 70 and the second antenna 72, which are FPC antennas, are flexible. In other words, the first antenna 70 and the second antenna 72 are readily deformed into shapes along the inner circumferential surfaces of the first housing 30 and the second housing 32. Therefore, the first antenna 70 and the second antenna 72 are readily accommodated in the housings 30, 32.

The center in the longitudinal direction of the first antenna 70 is disposed on a first side surface 62c of the circuit board 62. When the first antenna 70 has a flat shape that is not curved, the first antenna 70 extends from the first side surface 62c to the opposite sides in a direction orthogonal to the first main surface 62a and the second main surface 62b. In other words, when the first antenna 70 has a flat shape that is not curved, the first antenna 70 extends from the first side surface 62c in the positive direction and the negative direction of an x-axis. However, FIG. 6 illustrates the shape of the first antenna 70 in a state in which the first antenna 70 is accommodated in the space defined by the first housing 30 and the second housing 32. The first antenna 70 in this state extends from the first side surface 62c so as to face the first main surface 62a and the second main surface 62b. The first antenna 70 has an arch shape.

The center in the longitudinal direction of the second antenna 72 faces the center portion in a traverse direction of the first main surface 62a of the circuit board 62. When the second antenna 72 has a flat shape that is not curved, the second antenna 72 extends from the position facing the center portion in the traverse direction of the first main surface 62a to the opposite sides in the traverse direction of the first main surface 62a. In other words, when the second antenna 72 has a flat shape that is not curved, the second antenna 72 extends in the positive direction and the negative direction of they-axis from the position facing the center portion in the traverse direction of the first main surface 62a. FIG. 6 illustrates the shape of the second antenna 72 in a state in which the second antenna 72 is accommodated in the space defined by the first housing 30 and the second housing 32. In this case, the second antenna 72 approaches the second main surface 62b as the second antenna 72 extends away in the traverse direction of the second main surface 62b from the position facing the center portion in the traverse direction of the first main surface 62a. The opposite end portions of the second antenna 72 respectively face the first side surface 62c and a second side surface 62d of the circuit board 62. The second antenna 72 has an arch shape.

FIG. 7 shows a configuration of the first antenna 70 and the second antenna 72.

As shown in FIG. 7, the first antenna 70 and the second antenna 72 are each constructed by forming a pattern of an element Em on a flexible printed circuit board Fp. The element Em is a conductor. The element Em is, for example, a copper foil pattern. The first antenna 70 and the second antenna 72 each transmit radio waves via the element Em.

As shown in FIG. 7, the element Em has a rectangular shape with a T-shaped cutout SL in a flat state. The element Em extends in a longitudinal direction D of the flexible printed circuit board Fp.

Therefore, when the first antenna 70 and the second antenna 72 are installed in the wirelessly rechargeable power supply device 10 as shown in FIG. 6, the direction in which the element Em of the first antenna 70 extends and the direction in which the element Em of the second antenna 72 extends are orthogonal to each other. Specifically, the direction in which the element Em extends at the center portion in the longitudinal direction of the first antenna 70 and the direction in which the element Em extends at the center portion in the longitudinal direction of the second antenna 72 are orthogonal to each other.

### Operation and Advantages of Present Embodiment

The wirelessly rechargeable power supply device 10 includes the first antenna 70 and the second antenna 72, which are two dipole antennas. The direction in which the element Em of the first antenna 70 extends and the direction in which the element Em of the second antenna 72 extends are orthogonal to each other. Accordingly, the direction in which the sensitivity of the first antenna 70 is lowest and the direction in which the sensitivity of the second antenna 72 is lowest are different from each other. Therefore, the power receiving performance in the direction in which the sensitivity of the first antenna 70 is lowest is compensated for by the second antenna 72. Also, the power receiving performance in the direction in which the sensitivity of the second antenna 72 is lowest is compensated for by the first antenna 70. Therefore, the power receiving capability for signals transmitted from various directions is improved without mechanically changing the directions of the antennas 70, 72.

The direction in which the element Em of the first antenna 70 extends and the direction in which the element Em of the second antenna 72 extends are both orthogonal to the longitudinal direction of the circuit board 62. Accordingly, for example, in a case in which the terminals of the wirelessly rechargeable power supply device 10 are disposed at the opposite end portions in the longitudinal direction of the circuit board 62, the terminals and the components on the circuit board 62 can be readily connected to each other.

In a case in which two dipole antennas are provided, it is conceivable that the directions in which the elements Em of the antennas extend are the same and the directivities of the antennas are opposite to each other. For example, a dipole antenna having a directivity oriented in the positive direction of the x-axis in FIG. 6 and a dipole antenna having a directivity oriented in the negative direction of the x-axis may be provided. This would increase the gain in the negative direction on the x-axis as compared with a case in which only a dipole antenna having a directivity oriented in the positive direction of the x-axis is provided. However, in this case, for example, the gain in the positive direction of the z-axis in FIG. 6 decreases.

### Other Embodiments

The above-described embodiment may be modified as follows. The above-described embodiment and the following modifications can be combined as long as the combined modifications remain technically consistent with each other.

The rechargeable battery is not limited to a lithium-ion rechargeable battery, but may be a nickel metal-hydride rechargeable battery, for example. The power storage device does not necessarily need to be a rechargeable battery. The power storage device may be, for example, a capacitor.

The use of the communication antenna 14 is not limited to enabling the wirelessly rechargeable power supply device 10 to function as a beacon, and may be, for example. For example, the communication antenna 14 may also be used to transmit data on the discharge current of the wirelessly rechargeable power supply device 10 at each moment in time. This enables collection of data on the power consumption and the time periods of power consumption by the users of the wirelessly rechargeable power supply device 10.

The wirelessly rechargeable power supply device 10 does not necessarily need to include the communication antenna 14.

The main surfaces of the circuit board do not necessarily need to be rectangular. For example, w % ben the wirelessly rechargeable power supply device has a shape different from that of a dry battery, the housings 30, 32 may have a shape in which a longitudinal direction cannot be defined. In this case, the shape of the circuit board may be a shape whose longitudinal direction cannot be defined, such as a square shape.

In FIG. 6, the cutout SL of the first antenna 70 is disposed so as to open in the negative direction on the z-axis. However, the present disclosure is not limited to this. For example, the cutout SL may be disposed so as to open in the positive direction of the z axis.

In FIG. 6, the cutout SL of the second antenna 72 is disposed so as to open in the negative direction on the z-axis. However, the present disclosure is not limited to this. For example, the cutout SL may be disposed so as to open in the positive direction of the z axis.

The first antenna 70 and the second antenna 72 do not necessarily need to be disposed on the opposite sides in the longitudinal direction of the circuit board 62. For example, the first antenna 70 and the second antenna 72 may be disposed side by side at the center portion in the longitudinal direction of the circuit board 62.

When the longitudinal direction cannot be defined on the circuit board, the first antenna 70 and the second antenna 72 may be disposed at opposite end portions of one surface of the circuit board, for example. Any arrangement is permissible as long as the first antenna 70 and the second antenna 72 are disposed side by side in one direction along the circuit board.

The direction in which the element Em of the first antenna 70 extends and the direction in which the element Em of the second antenna 72 extends do not necessarily need to be orthogonal to each other. Even when the directions in which the elements Em of the two antennas 70, 72 extend are different from each other but the angle formed by these directions is smaller than 90°, the directions in which the sensitivities of the two antennas 70, 72 are lowest are different from each other. Therefore, as compared with a case in which the extending directions of the elements Em of the antennas 70, 72 are the same, the sensitivity in the direction in which the sensitivity is the lowest is prevented from becoming excessively low.

The shapes of the first antenna and the second antenna do not necessarily need to be the shape illustrated in FIG. 7.

The two or more antennas are not limited to the first antenna 70 and the second antenna 72, and may be three or more antennas, for example. Specifically, for example, in the configuration illustrated in FIG. 6, a third antenna having an element Em extending in the z-axis direction may be added. Even in a case in which three or more antennas are provided, it is desirable that the antennas be connected to the rectifier circuit 20a via different coaxial cables. This reduces loss due to noise as compared with a case in which multiple antennas are connected to a charging circuit by the same coaxial cable.

When three or more antennas are provided, the directions in which the elements of the antennas extend do not necessarily need to be different from one another. For example, in a case in which four antennas are provided, the four antennas may be divided into two groups, and the directions in which the elements extend may be different between the groups, but the directions in which the elements extend may be the same in the same group.

The two more antennas do necessarily need to both be flexible printed circuit board antennas.

The two more antennas do necessarily need to both be dipole antennas.

It is not necessary to provide a coaxial cable connecting an antenna and the rectifier circuit 20a for each antenna.

The wirelessly rechargeable power supply device 10 does not necessarily need to have the same shape and the same dimensions as those of an AA dry battery. For example, the wirelessly rechargeable power supply device 10 may have the same shape and the same dimensions as those of a D dry battery. Also, the wirelessly rechargeable power supply device 10 may have the same shape and the same dimensions as those of a C dry battery. Also, the wirelessly rechargeable power supply device 10 may have the same shape and the same dimensions as those of an AAA dry battery.

The wirelessly rechargeable power supply device is not limited to a columnar device, but may be a rectangular parallelepiped device such as a 9-volt dry cell.

The wirelessly rechargeable power supply device does not necessarily need to haves the same dimensions and the same shape as a dry cell.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A wirelessly rechargeable power supply device, comprising:
a circuit board:
a power storage device:
two or more antennas configured to receive power;
a housing that accommodates the circuit board, the power storage device, and the two or more antennas; and
a charging circuit that is mounted on the circuit board and is configured to charge the power storage device with the power received by the two or more antennas, wherein
the two or more antennas include a first antenna and a second antenna, and
a direction in which a sensitivity of the first antenna is lowest and a direction in which a sensitivity of the second antenna is lowest are different from each other.

2. The wirelessly rechargeable power supply device according to claim 1, wherein
the first antenna and the second antenna are both dipole antennas,
the first antenna and the second antenna are arranged side by side in one direction along the circuit board, and
a direction in which an element of the first antenna extends and a direction in which an element of the second antenna extends are different from each other.

3. The wirelessly rechargeable power supply device according to claim 2, wherein the direction in which the element of the first antenna extends and the direction in which the element of the second antenna extends are orthogonal to each other.

4. The wirelessly rechargeable power supply device according to claim 2, wherein the direction in which the element of the first antenna extends and the direction in which the element of the second antenna extends are both orthogonal to the one direction along the circuit board.

5. The wirelessly rechargeable power supply device according to claim 2, wherein the first antenna and the second antenna are arranged side by side in a longitudinal direction of the circuit board.

6. The wirelessly rechargeable power supply device according to claim 5, wherein the direction in which the element of the first antenna extends and the direction in which the element of the second antenna extends are both orthogonal to the longitudinal direction of the circuit board.

7. The wirelessly rechargeable power supply device according to claim 1, further comprising a first coaxial cable and a second coaxial cable, wherein
the first antenna is connected to the charging circuit via the first coaxial cable, and
the second antenna is connected to the charging circuit via the second coaxial cable.

8. The wirelessly rechargeable power supply device according to claim 1, wherein
the first antenna and the second antenna are both flexible printed circuit board antennas, and
the first antenna and the second antenna are arranged along an inner circumference of the housing.

9. The wirelessly rechargeable power supply device according to claim 1, further comprising a communication antenna and a communication control unit, wherein
the communication antenna is configured to receive radio waves from an external device and transmit radio waves to the external device, and
the communication control unit is configured to control communication with the external device.

10. The wirelessly rechargeable power supply device according to claim 1, wherein
the wirelessly rechargeable power supply device is a columnar member including a top surface and a bottom surface, and
the wirelessly rechargeable power supply device comprises a positive electrode at the top surface and a negative electrode at the bottom surface.
